(19) United States
(12) Patent Application Publication
(10) Pub. No.: US 2023/0014154 A1
(43) Pub. Date: Jan. 19, 2023

(54) DECORATIVE FILM AND DECORATIVE ARTICLE USING SAME, AND SURFACE PROTECTIVE COMPOSITION

(71) Applicant: 3M INNOVATIVE PROPERTIES COMPANY, St. Paul, MN (US)

(72) Inventor: Ken Egashira, Kanagawa (JP)

(21) Appl. No.: 17/781,613

(22) PCT Filed: Dec. 1, 2020
(86) PCT No.: PCT/IB2020/061328

§ 371 Date: Jun. 1, 2022

(30) Foreign Application Priority Data
Dec. 5, 2019 (JP) 2019-220576

(51) Int. Cl. C08G 18/75; C08G 18/32; C08G 18/72

(52) U.S. Cl. CPC C08G 18/755; C08G 18/3246; C08G 18/721

(57) ABSTRACT

Provided is a decorative film having excellent weather resistance, scratch resistance, and elongation properties, and a decorative article using the same, and a surface protective composition that can exhibit such properties. A decorative film according to one embodiment of the present disclosure includes a surface protective layer. The surface protective layer contains a polyurethane resin obtained by reacting a composition containing a polycarbonate diol, and a trimer or higher multimer of a diisocyanate including a cyclohexane structure, a diisocyanate including a cyclohexane structure or a prepolymer thereof, or a mixture thereof, and the decorative film satisfies Formulas 1 to 3 below: 0≤X¹≤2.00 . . . Formula 1 X¹≤−0.7×X²+4.67 . . . Formula 2 X¹≥−0.7×X²+2.14 . . . Formula 3 where X¹ is a numerical value obtained by multiplying the number of branches from a branch point relative to a converted molecular weight of the polyurethane resin by 1000, and X² is a numerical value obtained by multiplying the number of cyclohexane structure portions included in the polyurethane resin relative to the converted molecular weight of the polyurethane resin by 1000.

### TECHNICAL FIELD

The present disclosure relates to a decorative film and a decorative article using the same, and a surface protective composition.

### BACKGROUND

In recent years, instead of painting, films having decorative properties are used, for example. Patent Document 1 (JP 5112646 B) discloses a decorative layer-forming film having a topcoat layer made of a polyurethane resin and a carrier film provided on a front surface side of the topcoat layer, wherein the polyurethane resin is made of a polyurethane resin composition containing an isocyanurate of isophorone diisocyanate and a polyester polyol at an isocyanate/polyol equivalent ratio of 1.1, the polyester polyol is a mixture containing a caprolactone diol with an average molecular weight of 700 or less and a polycarbonate diol at an equivalent ratio from 1:9 to 9:1 and having an average molecular weight of 1000 or less, the carrier film has an elongation at break at 20° C. of 147% or greater, and the polyurethane resin composition is in the middle of the reaction in the topcoat layer, and is directly laminated onto the topcoat layer in a state of exhibiting adhesiveness.

Patent Document 2 (JP 2013-237216 A) describes a decorative sheet including a front surface layer and an adhesive layer, wherein the front surface layer is a layer of polyurethane obtained by crosslinking a linear polyurethane resin with 0.1 to 2.0 equivalents of a curing agent relative to an acid value of a carboxyl group, and drying the crosslinked resin to form a coating film, the linear polyurethane resin being obtained by reacting, with a diamine chain extender, a polyurethane prepolymer obtained by reacting a polycarbonate diol having an alicyclic structure, an aliphatic diol containing the carboxyl group, and an isocyanate containing 4,4′-cyclohexylmethane diisocyanate, and the linear polyurethane resin having a molecular weight from 50000 to 350000 and an acid value of 20.0 to 30.0 mg·KOH/g.

### SUMMARY

### Technical Problem

The articles to be decorated are not limited to those having a flat shape, and include articles having a curved shape, a three-dimensional shape, and the like. When a decorative film is applied to such articles, a film having some degree of elongation properties is required. However, decorative films having favorable elongation properties generally tend to have poor scratch resistance due to their soft front surface layer.

Articles to which a decorative film is applied may be used in external environments. The decorative film used in such environments is exposed to sunlight or the like, and therefore deteriorated in appearance properties in some cases.

A polyurethane resin may be used as the material for the topcoat layer of the decorative film. Polyurethane is generally prepared by reacting a diisocyanate or a diisocyanate polymer with a polyol, but there are enormous combinations of these components. It is therefore extremely difficult to prepare a polyurethane resin that satisfies the scratch resistance and the elongation properties, which are conflicting properties, while having weather resistance.

The present disclosure provides a decorative film having excellent weather resistance, scratch resistance, and elongation properties and a decorative article using the same, and a surface protective composition that can exhibit such properties.

### Solution to Problem

One embodiment of the present disclosure provides a decorative film having a surface protective layer, wherein the surface protective layer contains a polyurethane resin obtained by reacting a composition containing a polycarbonate diol, and a trimer or higher multimer of a diisocyanate including a cyclohexane structure, a diisocyanate including a cyclohexane structure or a prepolymer thereof, or a mixture thereof, and the decorative film satisfies Formulas 1 to 3 below:

0≤X¹≤2.00 Formula 1

X¹≤−0.7×X²+4.67 Formula 2

X¹≥−0.7×X²+2.14 Formula 3

wherein X¹ is a numerical value obtained by multiplying the number of branches from a branch point relative to a converted molecular weight of the polyurethane resin by 1000, and X² is a numerical value obtained by multiplying the number of cyclohexane structure portions included in the polyurethane resin relative to the converted molecular weight of the polyurethane resin by 1000.

Another embodiment of the present disclosure provides a decorative article formed by covering and integrating a support member with the decorative film described above.

Still another embodiment of the present disclosure provides a surface protective composition containing: a polycarbonate diol, and a trimer or higher multimer of a diisocyanate including a cyclohexane structure, a diisocyanate including a cyclohexane structure or a prepolymer thereof, or a mixture thereof, wherein the surface protective composition satisfies Formulas 1 to 3 below:

0≤X¹≤2.00 Formula 1

X¹≤−0.7×X²+4.67 Formula 2

X¹≥−0.7×X²+2.14 Formula 3

wherein X¹ is a numerical value obtained by multiplying the number of branches from a branch point relative to a converted molecular weight of a polyurethane resin prepared from the composition by 1000, and X² is a numerical value obtained by multiplying the number of cyclohexane structure portions included in a polyurethane resin prepared from the composition relative to the converted molecular weight of the polyurethane resin by 1000.

### Advantageous Effects of Invention

The present disclosure can provide a decorative film having excellent weather resistance, scratch resistance, and elongation properties, and a decorative article using the same, and a surface protective composition that can exhibit such properties.

The above description will not be construed to mean that all embodiments of the present invention and all advantages of the present invention are disclosed.

### BRIEF DESCRIPTION OF THE DRAWINGS

FIG. 1 is a schematic diagram of a reaction mechanism of a polyurethane resin contained in a surface protective layer of a decorative film according to one embodiment of the present disclosure.

FIG. 2 is a graph of Formulas 1 to 3 derived from X¹ and X² based on various materials used in the examples and comparative examples of the present disclosure.

### DESCRIPTION OF EMBODIMENTS

Although representative embodiments of the present invention will now be described in greater detail for the purpose of illustration with reference to the drawings and the like, the present invention is not limited to these embodiments.

As used herein, “film” also includes an article referred to as a “sheet”.

As used herein, for example, “on” as in “a decorative layer disposed on a substrate film” intends the decorative layer being disposed directly on an upper side of the substrate film, or the decorative layer being indirectly disposed on the upper side of the substrate film with another layer interposed between the decorative layer and the substrate film.

As used herein, for example, “under” as in “an adhesive layer disposed under a substrate film” intends an adhesive layer being disposed directly on a lower side of the substrate film, or the adhesive layer being indirectly disposed on the lower side of the substrate film with another layer interposed between the adhesive layer and the substrate film.

In the present disclosure, the term “substantially” refers to including variations caused by for instance manufacturing errors, and is intended to mean that approximately ±20% variation is acceptable.

As used herein, “transparent” means that an average transmittance in a visible light region (wavelength from 400 nm to 700 nm) is 80% or greater, and may be desirably 85% or greater, or 90% or greater.

As used herein, “translucent” means that an average transmittance in a visible light region (wavelength from 400 nm to 700 nm) is less than 80%, and may be desirably 75% or less, and may be 10% or greater, or 20% or greater, and is intended to mean that an underlying layer is not completely hidden.

In the present disclosure, “(meth)acrylic” means acrylic or methacrylic, and “(meth)acrylate” means acrylate or methacrylate.

Hereinafter, the decorative film, decorative article and surface protective composition according to the present disclosure will be described.

The decorative film of the present disclosure has at least a surface protective layer. The surface protective layer contains a polyurethane resin obtained by reacting a composition containing a polycarbonate diol, and a trimer or higher multimer of a diisocyanate including a cyclohexane structure, a diisocyanate including a cyclohexane structure or a prepolymer thereof, or a mixture thereof. A surface protective composition, which will be described below, can be used as such a composition.

The blending proportion of the polyurethane resin in the surface protective layer is not particularly limited, but is preferably 50 mass % or greater, 70 mass % or greater, 90 mass % or greater, or 95 mass % or greater, more preferably 100 mass %, from the perspective of weather resistance, scratch resistance, and elongation properties.

The polycarbonate diol is not particularly limited, and examples thereof can include polycarbonate diols having the following chemical formula:

HO—[ROC(═O)O]_{N}—R—OH

wherein R is one type alone or a combination of two or more types selected from —CH₂—(C₆H₁₀)—CH₂—, —(CH₂)ₘ—, —(CH₂)ₚ—CH(CH₃)(CH₂)_{q}—, and other caprolactone diols and carboxylic acid-derived structures, and n, m, p, and q are all integers. Preferred are —CH₂—(C₆H₁₀)—CH₂—, —(CH₂)ₘ— wherein m is 3 to 9, and —(CH₂)ₚ—CH(CH₃)(CH₂)_{q}— wherein a sum of p and q is 3 to 9. More preferred are —CH₂—(C₆H₁₀)—CH₂—, —(CH₂)ₘ— wherein m is 5 to 6, and —(CH₂)ₚ—CH(CH₃)(CH₂)_{q}— wherein p is 2 and q is 2.

Here, the C₆H₁₀ moiety corresponds to the cyclohexane structure portion in the polyurethane resin. Also, in the present disclosure, “polycarbonate diol” may be abbreviated as “PCDL”.

From the perspective of elongation properties, scratch resistance, and the like, the weight average molecular weight of the polycarbonate diol can be set to 3000 or less, 2500 or less, 2000 or less, 1500 or less, or 1000 or less, and can be set to 500 or greater, 600 or greater, 700 or greater, or 800 or greater. As used herein, “weight average molecular weight” means a weight average molecular weight in terms of polystyrene as measured by gel permeation chromatography (GPC).

In the present disclosure, “weight average molecular weight” may be referred to simply as “molecular weight”.

Examples of commercially available polycarbonate diols can include “Nippolan (trade name) 981” and “Nippolan (trade name) 983” available from Tosoh Corporation; “DURANOL (trade name) T4671”, “DURANOL (trade name) T4691”, “DURANOL (trade name) T5651”, “DURANOL (trade name) T5650J” and “DURANOL (trade name) T5650E” available from Asahi Kasei Corporation; and “ETERNACOLL (trade name) UH-100”, “ETERNACOLL (trade name) UC-100”, “ETERNACOLL (trade name) UM-90 (3/1),” “ETERNACOLL (trade name) UM-90 (1/1),” and “ETERNACOLL (trade name) UM-90 (1/3)” available from Ube Industries, Ltd.

A different diol component other than the polycarbonate diol, for example, polycaprolactone diol, may be blended, as a diol component, in the composition used in the preparation of the polyurethane resin, as long as it does not affect the effects of the invention of the present application. The amount of the different diol component blended in the composition can be set to 10 mass % or less, 5 mass %, or less, or 1 mass % or less of the total mass of all the diol components. However, the different diol component is, advantageously, not contained in the composition, from the perspective of weather resistance, scratch resistance, elongation properties, and the like. The proportion of the different diol component in the polyurethane resin prepared using a composition having such a formulation is 10% or less, 5% or less, 1% or less, or 0%. The proportion of the different polyol component in the polyurethane resin can be measured by FTIR (Fourier transform infrared spectroscopy), gas chromatography, or mass spectrometry.

The polyurethane resin of the present disclosure is prepared using a trimer or higher multimer of a diisocyanate including a cyclohexane structure, a diisocyanate including a cyclohexane structure or a prepolymer thereof, or a mixture thereof.

Examples of the diisocyanate including a cyclohexane structure can include isophorone diisocyanate (IPDI), hydrogenated xylylene diisocyanate (H6XDI), and hydrogenated xylylene diisocyanate (H12MDI). Examples of the trimer or higher multimer can include isocyanurates of IPDI (VESTANAT (trade name) T1890, available from Evonik Industries, and Desmodur (trade name) Z4470 available from Covestro AG, and isocyanurates of H6XDI (TAKENATE (trade name) D-127N available from Mitsui Chemicals, Inc.); a trimethylolpropane adduct of IPDI (TAKENATE (trade name) D-140N available from Mitsui Chemicals, Inc.); and a trimethylolpropane adduct of H6XDI (TAKENATE (trade name) D-120N available from Mitsui Chemicals, Inc.).

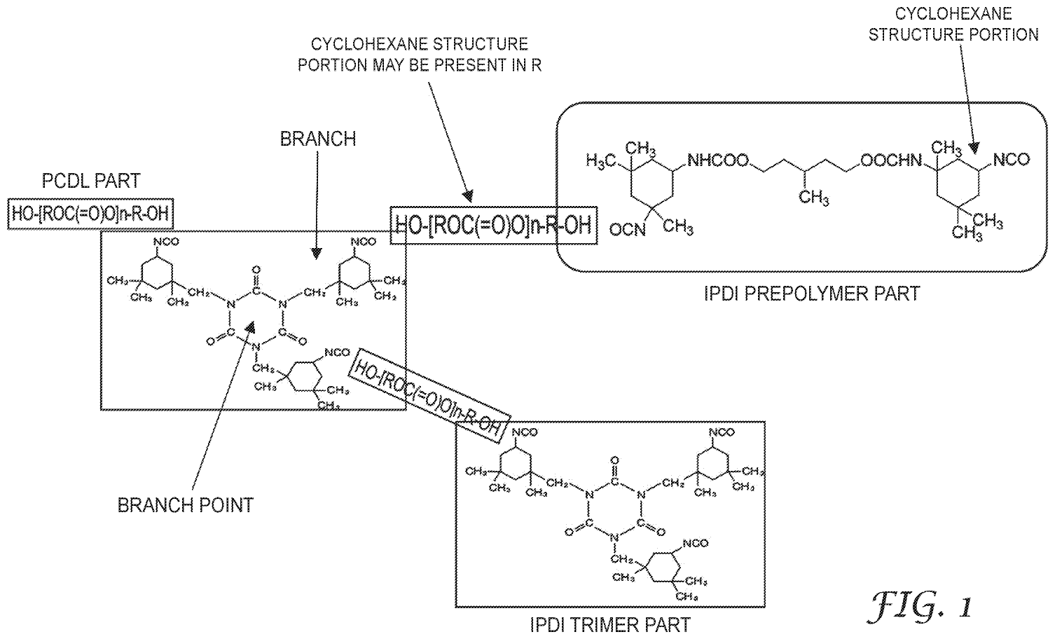

The isocyanurate refers to a trimer, but a pentamer, a heptamer, and the like are synthesized together. For example, the trimer of isophorone diisocyanate means one compound formed by reacting three isophorone diisocyanate monomers represented as “IPDI trimer part” in FIG. 1.

Similarly, the pentamer means one compound formed through a reaction of five isophorone diisocyanate monomers, and the heptamer means one compound formed through a reaction of seven isophorone diisocyanate monomers. Commercially available products, for example, even when designated as “trimers”, may also include pentamers, heptamers, and the like.

From the perspective of weather resistance, elongation properties, scratch resistance, and the like, the weight average molecular weight of the trimer or higher multimer of the diisocyanate including a cyclohexane structure can be set to 2000 or less, 1500 or less, or 1000 or less, and can be 500 or greater, 600 or greater, 700 or greater, or 800 or greater.

The diisocyanate prepolymer including a cyclohexane structure means a state in which two hydroxyl groups of an alkyl diol are bonded, through a urethane reaction, to isocyanate groups (NCO groups) of diisocyanate monomers one to one. For example, the isophorone diisocyanate prepolymer illustrated as the “IPDI prepolymer part” in FIG. 1 is a product obtained through a urethane reaction of hydroxyl groups of 3-methyl-1,5-pentanediol and isocyanate groups of two IPDI monomers. Here, the IPDI monomers each have a site where only the NCO group are branched from the cyclohexane ring moiety, and a site where the NCO group and the CH₃ group are branched from the cyclohexane ring. Because the hydroxyl groups of 3-methyl-1,5-pentanediol each react with either of the NCO groups, the structure of the IPDI prepolymer part in FIG. 1 is a mere example of the diisocyanate prepolymer including a cyclohexane structure.

Examples of the alkyl diol that can be used in the preparation of the diisocyanate prepolymer including a cyclohexane structure include linear or branched glycols and diols such as ethylene glycol, propylene glycol, diethylene glycol, dipropylene glycol, triethylene glycol, tripropylene glycol, 1,4-butanediol, 1,6-hexanediol, 1,8-octanediol, 1,9-nonanediol; 2-methyl-1,8-octanediol, 3-methyl-1,5-pentanediol, 2,4-diethyl-1,5-pentanediol, 2-butyl-2-ethyl-1,3-propanediol, neopentyl glycol, cyclohexane diol, cyclohexane dimethanol, polycaprolactone diol, and polycarbonate diol. Among these, the alkyl diol is preferably a branched alkyl diol, more preferably 3-methyl-1,5-pentanediol, from the perspective of elongation properties, weather resistance, scratch resistance, and the like.

From the perspective of weather resistance, elongation properties, scratch resistance, and the like, the weight average molecular weight of the diisocyanate prepolymer including a cyclohexane structure can be set to 2000 or less, 1500 or less, 1200 or less, or 1000 or less, and can be set to 300 or greater, 400 or greater, or 500 or greater.

Examples of commercially available diisocyanate prepolymers including a cyclohexane structure include the isophorone diisocyanate prepolymer “FB-827 PN” available from Sannan Gosei Kagaku K. K.

The polyurethane resin of the present disclosure can be prepared using a trimer or higher multimer of a diisocyanate including a cyclohexane structure, a diisocyanate including a cyclohexane structure or a prepolymer thereof, or a mixture thereof. In this case, particularly significant effects can be exhibited in elongation properties, weather resistance, and scratch resistance.

The composition used in the preparation of the polyurethane resin may be blended with a different non-yellowing isocyanate other than the trimer or higher multimer of a diisocyanate including a cyclohexane structure and the diisocyanate including a cyclohexane structure or prepolymer thereof, for example, an isocyanurate, adduct or biuret of hexamethylene diisocyanate (HDI), as an isocyanate component, as long as it does not affect the effects of the present invention. The amount of the different isocyanate component blended in the composition can be set to 10 mass % or less, 5 mass %, or less, or 1 mass % or less of the total mass of all the isocyanate components. However, the different isocyanate component is, advantageously, not contained in the composition, from the perspective of weather resistance, scratch resistance, elongation properties, and the like. The proportion of the different isocyanate component in the polyurethane resin prepared using a composition having such a formulation will be 10% or less, 5% or less, 1% or less, or 0%. The proportion of the different isocyanate component in the polyurethane resin can be measured by Fourier transform infrared spectroscopy (FTIR), gas chromatography, or mass spectrometry.

It is important for the polyurethane resin of the present disclosure to contain a composition containing a polycarbonate diol, and a trimer or higher multimer of a diisocyanate including a cyclohexane structure, a diisocyanate including a cyclohexane structure or a prepolymer thereof or a mixture thereof, as described above, and, additionally, to contain these components so that at least Formulas 1 to 3 below are satisfied. The polyurethane resin obtained by using specific materials so that the relationships of Formulas 1 to 3 below are satisfied can provide excellent results of the three properties, i.e., scratch resistance and elongation properties, which are conflicting properties, in addition to weather resistance.

Formulas 1 to 3 can be represented as follows:

0≤X¹≤2.00 Formula 1

X¹≤−0.7×X²+4.67 Formula 2

X¹≥−0.7×X²+2.14 Formula 3

In the formulas, X¹ means a numerical value obtained by multiplying the number of branches from a branch point relative to a converted molecular weight of the polyurethane resin by 1000. Here, “branch point” means, for example, a nurate ring moiety in the IPDI trimer part, i.e., a moiety serving as the origin of a branch, and “branch” means a moiety branched from such a branch point and including an isocyanate group (NCO group), as shown in FIG. 1 The isocyanate groups of such branch moieties can be bonded, through urethane reactions, with the hydroxyl groups of the polycarbonate diol to form a net-like network structure. That is, the number of branches from a branch point corresponds to the number of isocyanate groups (NCO groups) that are present in a state of being branched from the nurate ring moiety. As the value of X¹ increases, a denser network structure is formed. Here, the isophorone diisocyanate prepolymer has an isocyanate group, but there is no nurate ring moiety, i.e., no branch point, as shown in FIG. 1. Thus, a moiety where the isocyanate group of the isophorone diisocyanate prepolymer is present is not included in the number of branches from the branch point.

In the formula, X² means a numerical value obtained by multiplying the number of cyclohexane structure portions included in the polyurethane resin relative to the converted molecular weight of the polyurethane resin by 1000. A polyurethane resin obtained when the value of X² is small is flexible and is likely to exhibit a tendency to easily extend even at low temperatures. When the value of X² is large, the polyurethane resin is rigid and is likely to brittle at low temperatures. Here, “cyclohexane structure portion” is not limited to the cyclohexane moiety (—C₆H₁₀—) that may be included in the R groups of the polycarbonate diol described above, and means inclusion of, for example, cyclic moieties of cyclohexanes in the IPDI trimer part and IPDI prepolymer, as shown in FIG. 1. However, the cyclohexane structure portion includes no nurate ring structure. Here, the multiplication by 1000 in both X¹ and X² is intended to make the numerical values in the respective formulas easier to view.

The X¹ in the present disclosure can be determined as follows.

First, the equivalent blending ratio of the isocyanate groups (NCO groups), in total, of the diisocyanate multimer, diisocyanate and diisocyanate prepolymer to the hydroxyl groups (OH groups) of the polycarbonate diol and a different diol component, if present, is determined. In consideration of the deactivation of the NCO groups by moisture, the number of NCO groups/the number of OH groups is normally set to about 1.05 to 1.1/1. Of these, NCO groups excluding excessive NCO groups/OH groups=1/1 react to form a polyurethane. Next, X¹ can be calculated by dividing the blending ratio of diisocyanate multimers having isocyanate groups (NCO groups) corresponding to the number of branches from the branching point by the converted molecular weight of the polyurethane resin and multiplying the numerical value by 1000.

Here, the converted molecular weight of the polyurethane resin can be calculated by determining and combining the converted molecular weights of the respective moieties constituting the polyurethane resin as follows.

The converted molecular weight of the diisocyanate multimer moiety constituting the polyurethane resin can be determined as follows. The weight average molecular weight per NCO group of the diisocyanate multimer used and the equivalent blending ratio of the diisocyanate multimer corresponding to the number of NCO groups are multiplied, and thus the converted molecular weight of the diisocyanate multimer moiety constituting the polyurethane resin can be calculated. Concerning the weight average molecular weight per NCO group, for example, in the case of “VESTANAT (trade name) T1890E” used in the examples of the present application, the number of NCO groups per molecule is, on average, 3.35 from a solid content of 70% and an NCO content of 12.0%, and the number of monomers can be calculated to be, on average, 3.69 as the multimer. Since the diisocyanate multimer has a weight average molecular weight of 820, the weight average molecular weight per NCO group can be calculated to be about 245. The weight average molecular weight per NCO group of the diisocyanate multimer is designated as N1.

Since the diisocyanate or diisocyanate prepolymer has two NCO groups, the weight average molecular weight of the diisocyanate or diisocyanate prepolymer is divided by 2 to calculate the weight average molecular weight per NCO group of the diisocyanate or diisocyanate prepolymer. This value is designated as N2.

The converted molecular weight of the polycarbonate diol moiety constituting the polyurethane resin and a different diol component moiety, if present, can be calculated by multiplying the weight average molecular weight per OH group of the polycarbonate diol used and a different diol component, if present, and the equivalent blending ratio of the polycarbonate diol and a different diol component, if present, corresponding to the number of OH groups. Here, the weight average molecular weight per OH group can be calculated, for example, by dividing the weight average molecular weight of the polycarbonate diol by 2, because the polycarbonate diol has two OH groups. This value is designated as N3.

Because only the diisocyanate multimers have branches, the number of branches X¹ from the branch point relative to the converted molecular weight of the polyurethane resin can be calculated from Formula I below:

X¹=1000×M1/(M1×N1+M2×N2+M3×N3) Formula I

In Formula I, M1 can be determined from the amount of diisocyanate multimer blended/N1 which is the weight average molecular weight per NCO group, M2 can be determined from the amount of diisocyanate or diisocyanate prepolymer blended/N2 as the weight average molecular weight per NCO, and M3 can be determined from the amount of polycarbonate diol blended/N3 as the weight average molecular weight per OH. Here, the total converted molecular weight is M1×N1+M2×N2+M3×N3 because the polyurethane is formed by reacting at a ratio of M1+M2=M3.

The average number of NCO groups, the weight average molecular weight, and the like may be catalog values. Alternatively, the average number of NCO groups can be analyzed using a technique such as EN ISO11909 or ASTM D 2572, and the weight average molecular weight can be measured by gel permeation chromatography in terms of polystyrene.

The X² in the present disclosure can be determined as follows:

X²=1000×(M1×N1×C1+M2×N2×C2+M3×N3×C3)/(M1×N1+M2×N2+M3×N3) Formula II

In Formula II, C1 is the number of cyclohexanes per weight average molecular weight of the diisocyanate multimer, C2 is the number of cyclohexanes per weight average molecular weight of the diisocyanate or diisocyanate prepolymer, and C3 is the number of cyclohexanes per weight average molecular weight of the polycarbonate diol. The ways to determine M1, M2, and M3 are as described above.

For example, in the case of VESTANAT T1890E used in the examples of the present application, C1 is the number of cyclohexanes per weight average molecular weight of an isophorone diisocyanate multimer, which contains no other component. The isophorone diisocyanate has a weight average molecular weight of 222 and contains one cyclohexane structure, and thus C1=1/222=0.0045.

Concerning C2, for example, in the case of FB-827 PN used in the examples of the present application, the weight average molecular weight calculated from the solid content and the NCO % of the prepolymer obtained by reacting two isophorone diisocyanates and one 3-methyl-1,5-pentanediol, is 536. Each of the isophorone diisocyanates contains one cyclohexane structure, and thus C2=2/536=0.0037.

For example, in the case of the ETERNACOLL UM-90 (1/3) used in the examples of the present application, C3 is the number of cyclohexanes per weight average molecular weight of HO—[ROC(═O)O]ₙ—R—OH, and the R moieties include —CH₂—(C₆H₁₀)—CH₂— and —(CH₂)₆— at a ratio of 1/3. From the weight average molecular weight of 900, n can be calculated to be 6.15, of which —CH₂—(C₆H₁₀)—CH₂— is 1.54. Since —CH₂—(C₆H₁₀)—CH₂— has a single cyclohexane structure, C3=1.54/900=0.0017.

Further, when Formulas 1 to 3 above fall within the following ranges, the weather resistance, scratch resistance, and elongation properties can further be improved.

An upper limit value of X¹ in Formula 1 is preferably 1.70 or less, more preferably 1.50 or less. A lower limit of X¹ is preferably 0.10 or greater, more preferably 0.30 or greater.

Formula 2 preferably falls within the range of Formula 2A, more preferably falls within the range of Formula 2B:

X¹≤−0.7×X²+3.43 Formula 2A

X¹≤−0.7×X²+3.00 Formula 2B

Formula 3 preferably falls within the range of Formula 3A, more preferably falls within the range of Formula 3B:

X¹≥−0.7×X²+2.43 Formula 3A

X¹≥−0.7×X²+2.60 Formula 3B

The surface protective layer of the present disclosure contains the polyurethane resin prepared by the specific composition described above, and thus has excellent scratch resistance and elongation properties, which are conflicting performance, in addition to weather resistance. These properties can be defined, for example, by physical property values according to the following tests. A decorative film including the surface protective layer of the present disclosure can provide favorable results of, at least, a 60° gloss retention rate after a weather resistance test, a 60° gloss retention rate after a scratch recovery test, and a tensile elongation at break in an 80° C. atmosphere, among the following tests. Further, decorative films of some embodiments can provide favorable results of one or more of a 20° gloss retention rate after a weather resistance test, a 60° gloss retention rate immediately after a scratch resistance test, and a tensile elongation at break in a 120° C. atmosphere.

In some embodiments, the decorative film of the present disclosure can achieve a 60° gloss retention rate of 80% or greater, 85% or greater, or 90% or greater after the weather resistance test which will be described in the examples below. The upper limit of the gloss retention rate is not particularly limited, but can be defined as, for example, 100% or less, less than 100%, or 99% or less. The 60° gloss retention rate can be used to evaluate the decrease in the gloss of the decorative film surface after a weather resistance test. Note that the weather resistance test can be substituted for an accelerated test of integrated energy of 500 megajoules using a xenon arc weather resistance tester.

In some embodiments, the decorative film of the present disclosure can achieve a 20° gloss retention rate of 75% or greater, 77% or greater, or 80% or greater after the weather resistance test which will be described in the examples below. The upper limit of the gloss retention rate is not particularly limited, but can be defined as, for example, 95% or less, 93% or less, or 90% or less. The 20° gloss retention rate can be used to evaluate the increase or decrease in the turbidity (haze) of the decorative film surface after the weather resistance test, and is a more severe evaluation method compared to the 60° gloss retention rate.

In some embodiments, the decorative film of the present disclosure can achieve a 60° gloss retention rate of 80% or greater, 85% or greater, or 90% or greater, or 95% or greater after the scratch recovery test, as will be described in the examples below, which is one type of scratch resistance test. The upper limit of the gloss retention rate is not particularly limited, but can be defined as, for example, 100% or less. The polyurethane resin of the present disclosure is prepared using specific materials. Thus, even if scratches are formed on the surface of the surface protective layer, the polyurethane resin of the present disclosure can exhibit the action of attempting to recover a scratch when heat is applied to the scratched surface.

In some embodiments, the decorative film of the present disclosure can achieve a 60° gloss retention rate of 80% or greater, 85% or greater, or 90% or greater immediately after the scratch resistance test which will be described in the examples below. The upper limit of the gloss retention rate is not particularly limited, but can be defined as, for example, 100% or less, less than 100%, or 99% or less.

In some embodiments, the decorative film of the present disclosure can achieve a tensile elongation at break of 50% or greater, 80% or greater, or 100% or greater in the 80° C. atmosphere which will be described in the examples below. The upper limit of the tensile elongation at break is not particularly limited, but can be defined as, for example, 1000% or less, 900% or less, or 800% or less. For example, when a decorative film is bonded to an article surface by hand, the decorative film may be stretched. But, even in such cases, the decorative film of the present disclosure can reduce or prevent defects such as cracks.

In some embodiments, the decorative film of the present disclosure can achieve a tensile elongation at break of 100% or greater, 150% or greater, or 200% or greater in the 120° C. atmosphere which will be described in the examples below. The upper limit of the tensile elongation at break is not particularly limited, but can be defined as, for example, 850% or less, 800% or less, or 750% or less. For example, when a decorative film is bonded to an article surface using a vacuum pressure forming method, the decorative film may be stretched at high temperatures of 100° C. or higher. However, even in such cases, the decorative film of the present disclosure can reduce or prevent defects such as cracks.

The thickness of the surface protective layer of the present disclosure is not particularly limited, and, for example, can be set to 5 μm or greater, 10 μm or greater, or 15 μm or greater. The upper limit of the thickness is not limited to a particular thickness and, for example, may be 200 μm or less, 150 μm or less, or 100 μm or less. For the thickness of the surface protective layer, the cross section in the thickness direction of the decorative film is measured using a scanning electron microscope. Then, an average value of the thicknesses of at least five freely-selected points of the surface protective layer of the decorative film can be defined as the thickness of the surface protective layer. The thickness of any different layer that may constitute the decorative film can also be determined in the same manner.

In some embodiments, the surface protective layer may have a substantially flat surface or may have a protruded-recessed form, such as an embossed pattern, on the surface. The surface protective layer may have a single layer structure or a laminate structure. The surface protective layer may be transparent, translucent, or opaque entirely or partially in the visible light region.

In some embodiments, the surface protective layer may contain an optional component such as a filler, a colorant, benzotriazole, a UV absorber such as Tinuvin (trade name) 400 (available from BASF), or a hindered amine light stabilizer (HALS) such as Tinuvin (trade name) 292 (available from BASF). A UV absorber or a hindered amine light stabilizer can be used to effectively prevent color change, fading, deterioration and the like of a layer positioned under the surface protective layer.

In some embodiments, the decorative film of the present disclosure may further include at least one selected from the group consisting of, for example, a substrate film, a decorative layer, a brightening layer, a bonding layer, an adhesive layer, and a release liner, depending on an application of its use and the like.

The surface of the substrate film may be subjected to surface treatment such as corona treatment, plasma treatment, primer treatment, or the like.

Examples of materials for the substrate film include polyolefin resins such as polyvinyl chloride resins, polyurethane resins, and polypropylene resins, polyester resins such as polyethylene terephthalate resins, polycarbonate resins, polyimide resins, polyamide resins, (meth)acrylic resins, and fluororesins. These may be used alone or in combination of two or more of them.

The thickness of the substrate film is not particularly limited, and, for example, can be set to 30 μm or greater, 50 μm or greater, 80 μm or greater, or 100 μm or greater. The upper limit of the thickness is not particularly limited but can be, for example, 500 μm or less, 300 μm or less, or 200 μm or less, from the perspectives of followability and production cost, for example.

In the decorative film of the present disclosure, for example, the decorative layer may be disposed on or under the substrate film. The decorative layer can be applied, for example, to an entire surface or a portion of the substrate film.

Examples of the decorative layer include, but are not limited to: a color layer that exhibits a paint color, for example a light color such as white and yellow, or a dark color such as red, brown, green, blue, gray, and black; a pattern layer that imparts to an article a pattern, a logo, a design or the like such as a wood grain tone, a stone grain tone, a geometric pattern, and a leather pattern; a relief (embossed carving pattern) layer provided with an protruded and recessed shape on a surface; and combinations thereof.

As a material of the color layer, for example, a material in which a pigment such as an inorganic pigment such as carbon black, yellow lead, yellow iron oxide, Bengala, or red iron oxide; a phthalocyanine pigment such as phthalocyanine blue or phthalocyanine green; and an organic pigment such as an azo lake pigment, an indigo pigment, a perinone pigment, a perylene pigment, a quinophthalone pigment, a dioxazine pigment, and a quinacridone pigment such as quinacridone red is dispersed in a binder resin such as a (meth)acrylic resin or a polyurethane resin can be used. However, the material of the color layer is not limited thereto.

Such a material may be used to form the color layer by, for example, a coating method such as gravure coating, roll coating, die coating, bar coating, and knife coating, or a printing method such as inkjet printing.

As a pattern layer, a pattern layer obtained by, for example, directly applying a pattern, a logo, a design, or other such patterns to the substrate film or the like by using a printing method such as gravure direct printing, gravure offset printing, inkjet printing, laser printing, or screen printing may be adopted, or a film, a sheet, or the like having a pattern, a logo, a design, or the like formed by coating such as gravure coating, roll coating, die coating, bar coating, and knife coating, or by punching, etching, or the like may also be used. However, the pattern layer is not limited thereto. For example, a material similar to the material used in the color layer may be used as the material of the pattern layer.

As a relief layer, a thermoplastic resin film having a concavo-convex shape on a surface obtained by a conventionally known method such as embossing, scratching, laser machining, dry etching, or hot pressing may be used. The relief layer can also be formed by coating the release liner having a concavo-convex shape with a thermosetting or radiation curable resin such as a curable (meth)acrylic resin, curing by heating or radiation irradiation, and removing the release liner.

The thermoplastic resin, the thermosetting resin, and the radiation curable resin used in the relief layer are not particularly limited, and for example, a fluororesin, a polyester resin such as PET, and PEN, a (meth)acrylic resin, a polyolefin resin such as polyethylene, and polypropylene, a thermoplastic elastomer, a polycarbonate resin, a polyamide resin, an ABS resin, an acrylonitrile-styrene resin, a polystyrene resin, a vinyl chloride resin, and a polyurethane resin can be used. The relief layer may include at least one of the pigments used in the color layer.

The thickness of the decorative layer can be appropriately adjusted depending on, for example, required decorative properties and concealing properties and is not limited to a particular thickness, and may be, for example, 1 μm or greater, 3 μm or greater, or 5 μm or greater, and may be 50 μm or less, 40 μm or less, 30 μm or less, 20 μm or less, or 15 μm or less.

The brightening layer is not limited to the following, but may be a layer that includes a metal selected from aluminum, nickel, gold, silver, copper, platinum, chromium, iron, tin, indium, titanium, lead, zinc, and germanium, or an alloy or a compound thereof, and that is formed by vacuum deposition, sputtering, ion plating, plating, or the like on an entire surface or a part of the substrate film or the decorative layer. The thickness of the brightening layer may be selected arbitrarily according to the required decorative property, brightness and the like.

A bonding layer (may be referred to as a “primer layer” or the like) may be used to bond the layers constituting the decorative film. As a bonding layer, for example, a commonly used (meth)acrylic-based, polyolefin-based, polyurethane-based, polyester-based, or rubber-based solvent type, emulsion type, pressure sensitive type, heat sensitive type, thermosetting type, or UV curing type adhesive may be used. The bonding layer may be applied by a known coating method or the like.

The thickness of the bonding layer may be, for example, 0.05 μm or greater, 0.5 μm or greater, or 5 μm or greater, and may be 100 μm or less, 50 μm or less, 20 μm or less, or 10 μm or less.

The decorative film may further have an adhesive layer to adhere the decorative film to an adherend. As a material of the adhesive layer, materials that are the same as that of the bonding layer may be used. The adhesive layer may be applied to an adherend instead of the decorative film.

The thickness of the adhesive layer may be, but not limited to, for example, 5 μm or greater, 10 μm or greater, or 20 μm or greater, and may be 200 μm or less, 100 μm or less, or 80 μm or less.

The substrate film, the decorative layer, the bonding layer and the adhesive layer according to the present disclosure may include, as an optional component, for example, a filler, a reinforcing material, an antioxidant, a UV absorber, a light stabilizer, a thermal stabilizer, a tackifier, a dispersant, a plasticizer, a flow improving agent, a surfactant, a leveling agent, a silane coupling agent, a catalyst, a pigment, and a dye, within the range that does not inhibit the effects of the present disclosure and decorative properties.

Any suitable release liner may be used to protect the adhesive layer. Examples of a typical release liner include those prepared from paper (e.g., kraft paper), and from polymeric materials (e.g., polyolefin such as polyethylene or polypropylene, ethylene vinyl acetate, polyurethane, polyethylene terephthalate, and other such polyester). On the release liner, a layer of a release agent such as a silicone-containing material or a fluorocarbon-containing material may be applied as necessary.

The thickness of the release liner may be, for example, 5 μm or greater, 15 μm or greater, or 25 μm or greater, and may be 300 μm or less, 200 μm or less, or 150 μm or less.

The decorative film of the present disclosure can be appropriately prepared by a single or a combination of a plurality of publicly known methods, such as printing methods including gravure direct printing, gravure offset printing, inkjet printing, and screen printing, coating methods such as gravure coating, roll coating, die coating, bar coating, knife coating, and extrusion coating, lamination methods, and transfer methods.

As an example, the following production method is described below; however, the production method of the decorative film of the present disclosure is not limited to this. For example, in the case of the decorative film including, in this order, the release liner, the adhesive layer, the substrate film, the decorative layer and the surface protective layer described above, an adhesive is coated on the substrate film, and, as necessary, a drying step and a curing step are applied. Thereafter, the release liner is bonded to the adhesive layer to prepare a laminate A. A decorative composition containing a pigment and a binder resin is coated on a surface of the substrate film of the laminate A, and, as necessary, a drying step and a curing step are applied to prepare the decorative layer. Then, the decorative layer is coated with a surface protective composition which will be described below. As necessary, a heating and drying step is applied, and a urethane reaction is allowed to proceed to form the surface protective layer. Hence, the decorative film can be prepared. The formation of the surface protective layer may be implemented by molding the surface protective composition in the form of a film or sheet, and then bonding the film or sheet.

In some embodiments, a support member may be covered and integrated with the decorative film of the present disclosure to form a decorative article. The decorative film of the present disclosure has excellent elongation properties and thus can be applied not only to a flat plate-shaped support member but also to a curved or three-dimensional support member. The decorative film of the present disclosure also has excellent weather resistance and scratch resistance and thus can be used in various applications.

The material for the support member is not particularly limited, and, for example, a resin material, an inorganic material such as glass, a metal material, and a ligneous material can be used.

In some embodiments, the decorative film of the present disclosure can be used, for example, for interior or exterior components for decoration, such as interior or exterior components of vehicles including cars, trains, aircraft, and ships (e.g., roof components, pillar components, door trim components, instrument panel components, front components such as hood, bumper components, fender components, and side sill components), and building components (e.g., window glass, doors, window frames, roof component such as tiles, outer wall components, and wall papers). In addition, the decorative film of the present disclosure can be used for electronic products such as personal computers, smartphones, mobile phones, refrigerators, and air conditioning devices, stationery, furniture, desks and the like.

The method of applying the decorative film of the present disclosure to a support member (adherend) constituting the decorative article is not particularly limited, and a known method can appropriately be used. Examples of such a method include bonding by hand, injection molding methods such as an insert injection molding method, in-mold molding method, over-mold molding method, two color injection molding method, core-back injection molding method, and sandwich injection molding method, lamination method, and 3D heat expansion molding method (TOM).

The surface protective composition of the present disclosure contains: a polycarbonate diol, and a trimer or higher multimer of a diisocyanate including a cyclohexane structure, a diisocyanate including a cyclohexane structure or a prepolymer thereof, or a mixture thereof, and the surface protective composition satisfies Formulas 1 to 3 below:

0≤X¹≤2.00 Formula 1

X¹≤−0.7×X²+4.67 Formula 2

X¹≥−0.7×X²+2.14 Formula 3

wherein X¹ is a numerical value obtained by multiplying the number of branches from a branch point relative to a converted molecular weight of a polyurethane resin prepared from the composition by 1000, and X² is a numerical value obtained by multiplying the number of cyclohexane structure portions included in a polyurethane resin prepared from the composition relative to the converted molecular weight of the polyurethane resin by 1000.

As the various materials contained in the surface protective composition, for example, the polycarbonate diol, and the trimer or higher multimer of a diisocyanate including a cyclohexane structure, or the diisocyanate including a cyclohexane structure or prepolymer thereof, the same materials as those used in the surface protective layer of the decorative film described above can be used. The surface protective composition of the present disclosure can similarly satisfy the relationships of Formulas 1 to 3 and 2A to 3B of the surface protective layer described above.

The polyurethane resin obtained from the surface protective composition of the present disclosure can exhibit weather resistance, scratch resistance, and elongation properties as described above. Thus, such a composition can be used in the preparation of the surface protective layer of the decorative film described above, and, additionally, can also be used in other applications requiring weather resistance, scratch resistance, and the like. For example, the surface protective composition of the present disclosure can also be used as a waterproof material, a sealing material, a paving material, or the like.

The surface protective composition of the present disclosure may be applied to a support member by various printing methods or coating methods as described above, or may be processed into a form of a film, a sheet or the like, and applied to the support member using a lamination method, a transfer method or the like.

The surface protective composition of the present disclosure may be blended with an optional component such as a filler, a reinforcing material, an antioxidant, a UV absorber, a light stabilizer, a thermal stabilizer, a tackifier, a dispersant, a plasticizer, a flow improving agent, a surfactant, a leveling agent, a silane coupling agent, a catalyst, a pigment, a dye, a thickener, a polymerization initiator, a crosslinker, a curing agent, a curing promoter, a solvent (for example, an aqueous solvent or an organic solvent), or the like, within the range that does not inhibit the effects of the present disclosure.

### EXAMPLES

Specific embodiments of the present disclosure will be exemplified in the following examples, but the present invention is not limited to these embodiments. All parts and percentages are based on mass unless otherwise specified.

Products and the like used in the examples are shown in Table 1 below. Here, “Mw” in Table 1 means the weight average molecular weight, and “cyclic structure proportion” refers to the proportion of the number of units having a cyclohexane structure in the polyol or isocyanate.

TABLE 1

| Compound name, product name or | | |
|---|---|---|
| abbreviation | Description | Source of supply |
| DURANOL (trade name) T5650J | Polycarbonate diol, solid content: 100%, Mw: 800. OH group: | Asahi Kasei |
| | bifunctional, cyclic structure proportion: 0%, N3: 400 | Corporation |
| DURANOL (trade name) T5650E | Polycarbonate diol, solid content: 100%, Mw: 500, OH group: | Asahi Kasei |
| | bifunctional, cyclic. structure proportion: 0%, N3: 250 | Corporation |
| ETERNACOLL (trade name) UC-100 | Polycarbonate diol, solid content: 100%, Mw; 1000, OH group: | Ube Industries, Ltd. |
| | bifunctional, cyclic structure proportion: 100%, N3: 500 | |
| ETERNACOLL (trade name) UM-90 (3/1) | Polycarbonate diol, solid content: 100%, Mw 900, OH group: | Ube Industries. Ltd. |
| | bifunctional, cyclic structure proportion: 75%, N3:450. C3: 0.0047 | |
| ETERNACOLL (trade name) UM-90 (1/1) | Polycarbonate diol, solid content: 100%, Mw 900. OH group: | Ube Industries, Ltd. |
| | bifunctional, cyclic structure proportion: 50%, N3:450, C3: 0.0033 | |
| ETERNACOLL (trade name) UM-90 (1/3) | Polycarbonate diol, solid content: 100%, Mw: 900, OH group: | Ube Industries, Ltd. |
| | bifunctional, cyclic structure proportion: 25%, N3:450, C3: 0.0017 | |
| ETERNACOLL (trade name) UH-100 | Polycarbonate diol, solid content: 100%. Mw: 1000, OH group: | Ube Industries, Ltd. |
| | bifunictional, cyclic structure proportion: 0%, N3: 500 | |
| Desmophenr (trade name) A565 | Acrylic polyol, solic content: 100%. | CovestroAG |
| | Mw; 19000, OH group: polyfunctional | |
| Tinuvin (trade name) 292 | HALS (light stabilizer), solid content: 100% | BASF Japan Ltd. |
| Tinuvin (trade name) 99-2 | UVA (UV absorber), solid content: 95% | BASF Japan Ltd. |
| Tinuvin (trade name) B75 | HALS/UVA mixture, solid content: 75% | BASF Japan Ltd. |
| Acetylacetone | Negative catalyst | Tokyo Chemical |
| | | Industry Co., Ltd |
| Dibutyltin dilaurate | Catalyst, solid content: 100% | Tokyo Chemical |
| | | Industry Co., Ltd |
| Naphtecs Zn 5% T | Catalyst, solid content: 5% | Nihon Kagaku . |
| | | Sangyo Co., Ltd |
| Butyl acetate | Solvent | Mitsui Kasei K.K, |
| PGM-AC | Solvent | Nippon Nyukazai |
| | | Co., Ltd. |
| UA-702 | Acrylic leveling agent, solid content 50% | Mitsui Kasei K.K. |
| VESTANAT (trade name)T1890E | IPDI trimer, solid content: 70%, Mw: 820, | Evonik Industries |
| | average number of NCO groups: 3.35, | |
| | Mw per NCO group: about 245, N1:245, C1: 0.0045 | |
| FB-827PN | NCO-terminated IPDI prepolymer obtained by reacting | Sannan Gosei |
| | 3-methyl-1,5-pentanediol and IPDI monomer, | Kagaku K.K. |
| | solid content: 65%, Mw: 536, NCO group: bifunctional, | |
| | NCO%: 10.2, N2:268, C2: 0.0037 | |
| Coronate (trade name) 2093 (HK) | HDI trimer, solid content 100%, Mw: 768, NCO group: trifunctional | Tosoh Corporation |
| BYK355 | Leveling agent, solid content: 50% | BYK |
| Additive 6947 | Leveling agent, solid content: 100% | BASF Japan Ltd. |

The materials shown in Table 1 were mixed at blending proportions shown in Table 2 to prepare each surface protective coating composition for fabricating a surface protective layer. The numerical values in Table 2 are all in units of parts by mass.

TABLE 2

| | Surface protective coating composition | | | | | | | | |
|---|---|---|---|---|---|---|---|---|---|
| | 1 | 2 | 3 | 4 | 5 | 6 | 7 | 8 | 9 |
| DURANOL (trade name) T5650J | 40 | — | — | — | — | — | — | — | — |
| DURANOL (trade name) T5650E | — | 40 | — | — | — | — | — | — | — |
| ETERNACOLL (trade name) UC-100 | — | — | 40 | — | — | — | — | — | — |
| ETERNACOLL (trade name) UM-90 (3/1) | — | — | — | 40 | — | — | — | 40 | 40 |
| ETERNACOLL (trade name) UM-90 (1/1) | — | — | — | — | 40 | — | — | — | — |
| ETERNACOLL (trade name) UM-90 (1/3) | — | — | — | — | — | 40 | — | — | — |
| ETERNACOLL (trade name) UH-100 | — | — | — | — | — | — | 40 | — | — |
| Desmophenr (trade name) A565 | — | — | — | — | — | — | — | — | — |
| Tinuvin (trade name) 292 | 1.0 | 1.0 | 0.6 | 0.6 | 0.6 | 0.6 | 0.6 | 0.6 | 0.6 |
| Tinuvin (trade name) 99-2 | 2.0 | 2.0 | 1.2 | 1.2 | 1.2 | 1.2 | 1.2 | 1.2 | 1.2 |
| Tinuvin (trade name) B75 | — | — | — | — | — | — | — | — | — |
| Acetylacetone | 2.0 | 3.0 | 1.4 | 1.4 | 1.4 | 1.4 | 1.4 | 1.4 | 1.4 |
| Dibutyitin dilaurate | 0.007 | 0.020 | 0.014 | 0.014 | 0.014 | 0.014 | 0.014 | 0.014 | 0.014 |
| Naphtecs Zn 5% T | — | — | — | — | — | — | — | — | — |
| Butyl acetate | 4.7 | 4.7 | 12.3 | 12.4 | 12.4 | 12.4 | 12.3 | 12.4 | 12.4 |
| PGM-AC | — | — | — | — | — | — | — | — | — |
| UA-702 | 4.7 | 4.7 | — | — | — | — | — | — | — |
| VESTANAT (trade name) T1890E | 39.0 | 45.8 | 8.7 | 34.6 | 34.6 | 34.6 | 31.1 | 17.3 | 8.6 |
| FB-827PN | — | — | — | — | — | — | — | 20.4 | 30.5 |
| Coronate (trade name) 2093 (HK) | — | — | — | — | — | — | — | — | — |
| BYK355 | 0.50 | 0.50 | — | — | — | — | — | — | — |
| Additive 6947 | — | — | — | — | — | — | — | — | — |
| Total | 93.8 | 101.7 | 64.3 | 90.2 | 90.2 | 90.2 | 86.7 | 93.3 | 94.8 |

| | Surface protective coating composition | | | | | | | |
|---|---|---|---|---|---|---|---|---|
| | 10 | 11 | 12 | 13 | 14 | 15 | 16 | 17 |
| DURANOL (trade name) T5650J | — | — | — | — | — | — | — | — |
| DURANOL (trade name) T5650E | — | — | — | — | — | — | — | — |
| ETERNACOLL (trade name) UC-100 | — | — | — | — | — | — | — | — |
| ETERNACOLL (trade name) UM-90 (3/1) | 40 | — | — | — | — | — | — | — |
| ETERNACOLL (trade name) UM-90 (1/1) | — | 40 | 40 | 40 | — | — | — | — |
| ETERNACOLL (trade name) UM-90 (1/3) | — | — | — | — | 40 | 40 | 40 | — |
| ETERNACOLL (trade name) UH-100 | — | — | — | — | — | — | — | — |
| Desmophenr (trade name) A565 | — | — | — | — | — | — | — | 60 |
| Tinuvin (trade name) 292 | 0.6 | 0.6 | 0.6 | 0.6 | 0.6 | 0.6 | 0.6 | — |
| Tinuvin (trade name) 99-2 | 1.2 | 1.2 | 1.2 | 1.2 | 1.2 | 1.2 | 1.2 | — |
| Tinuvin (trade name) B75 | — | — | — | — | — | — | — | 1.2 |
| Acetylacetone | 1.4 | 1.4 | 1.4 | 1.4 | 1.4 | 1.4 | 1.4 | — |
| Dibutyitin dilaurate | 0.014 | 0.014 | 0.014 | 0.014 | 0.014 | 0.014 | 0.014 | — |
| Naphtecs Zn 5% T | — | — | — | — | — | — | — | 0.030 |
| Butyl acetate | 12.4 | 12.4 | 12.4 | 12.4 | 12.4 | 12.4 | 12.4 | — |
| PGM-AC | — | — | — | — | — | — | — | 12.6 |
| UA-702 | — | — | — | — | — | — | — | — |
| VESTANAT (trade name) T1890E | — | 17.3 | 8.6 | — | 17.3 | 8.6 | — | — |
| FB-827PN | 40.8 | 20.4 | 30.5 | 40.8 | 20.4 | 30.5 | 40.8 | — |
| Coronate (trade name) 2093 (HK) | — | — | — | — | — | — | — | 19.6 |
| BYK355 | — | — | — | — | — | — | — | — |
| Additive 6947 | — | — | — | — | — | — | — | 0.13 |
| Total | 96.4 | 93.3 | 94.8 | 96.4 | 93.3 | 94.8 | 96.4 | 93.4 |

The surface protective layers of Examples 1 to 11 and Comparative Examples 1 and 6 were evaluated.

### Example 1

A surface of ALPHAN (trade name) PK-002 (biaxially-oriented polypropylene film), available from Oji F-Tex Co., Ltd., having a thickness of 40 microns was coated with a surface protective coating composition 1 using a knife coater. It was placed in a hot air oven at 80° C. for 4 minutes to prepare a clear, unreacted surface protective layer having a thickness of about 50 μm. Next, Lumirror (trade name) 50T60, available from Toray Co., Ltd., having a thickness of 50 μm, was laminated onto such a surface protective layer to prepare a laminate, and the laminate was held at room temperature (25 to 30° C.) for approximately one week or longer until the urethane reaction was completed.

### Comparative Examples 1 to 3

Surface protective layers of Comparative Examples 1 to 3 were each prepared in the same manner as in Example 1 except that surface protective coating compositions 2 to 4 were each used in place of the surface protective coating composition 1.

### Examples 2 to 11

Surface protective layers of Examples 2 to 11 were each prepared in the same manner as in Example 1 except that surface protective coating compositions 5 to 14 were each used in place of the surface protective coating composition 1.

### Comparative Examples 4 to 6

Surface protective layers of Comparative Examples 4 to 6 were each prepared in the same manner as in Example 1 except that surface protective coating compositions 15 to 17 were each used in place of the surface protective coating composition 1.

### Reference Examples

As a reference example, a center pillar component to be used as an exterior member of an automobile, which was fabricated by injection molding a black polymethylmethacrylate (PMMA) resin, was used as a reference example.

### Physical Property Evaluation Test

Properties of the respective surface protective layers were evaluated by using the following methods.

### Weather Resistance Test

ALPHAN (trade name) PK-002 and Lumirror (trade name) 50T60 were removed from each of the laminates prepared to produce a sheet of surface protective layer (hereinafter, referred to also as “surface protective sheet” in some cases). The surface protective sheet was laminated on a 30 μm thick acrylic-based adhesive layer (RD2737, available from 3M Japan Ltd.), which was coated onto a PET liner with a silicone release layer and crosslinked with an aziridine crosslinking agent (RD1054, available from 3M Japan Ltd.), and then cut into a size of approximately 30 mm×approximately 60 mm. Next, after removal of the PET liner, the acrylic-based adhesive layer was laminated on a black painted plate having a size of 70 mm×150 mm to prepare test samples for a weather resistance test.

Such test samples were placed in an outdoor environment in Okinawa at an angle of 45° from the horizontal plane and in such a manner that the surface protective sheet faced the south. The gloss (A) of the untested samples and the gloss (B) of the samples after testing were measured using a gross meter (GMX-203, available from MURAKAMI COLOR RESEARCH LABORATORY CO., LTD.), and 60° and 20° gloss retention rates B/A (%) were calculated. The results are shown in Table 3.

### Scratch Resistance Test

Similarly to the weather resistance test, a test sample for a scratch resistance test was prepared by laminating the surface protective sheet obtained from each laminate onto an acrylic-based adhesive layer, removing the PET liner, and then laminating the acrylic-based adhesive layer onto a black painted plate having a size of 70 mm×150 mm.

A mixture liquid containing two test powders according to JIS Z8901 and water at a weight ratio of 1:4 was applied to a surface of the test sample and dried. A panel to which the test sample was bonded was fixed so as to be substantially perpendicular to the ground surface, and a washing car brush equipped with a polypropylene brush having a length of 210 mm was placed at a distance of 200 mm from the panel and rotated. After the panel surface was rubbed off for 30 seconds at a speed of 200 mm/min, the powder of the panel surface was rinsed off with water, and the moisture was then wiped off. The gloss (A) of the untested samples and the gloss (B) of the samples after testing were measured using a gross meter (GMX-203, available from MURAKAMI COLOR RESEARCH LABORATORY CO., LTD.), and 60° gloss retention rates B/A (%) were calculated.

Furthermore, the gloss retention rate was similarly determined after application of 50 cc of hot water at 80° C. to the surface after testing. The results are shown in Table 3. Here, the 60° gloss retention rate measured when using hot water at 80° C. can be used to evaluate the recovery of scratches due to heat, and thus, in Table 3, this evaluation item is labeled as “60° gloss retention rate after scratch recovery test”.

### Tensile Elongation at Break Test

The surface protective sheet obtained from each laminate was cut into a size of 50 mm×100 mm. A 25-mm wide Kapton (trade name) tape was bonded to both longitudinal ends so that the size of the exposed surface protective sheet was 50 mm×50 mm. Next, after both ends were bonded to an aluminum plate using a 50 mm-wide Kapton (trade name) tape, the aluminum plate was gripped with a chuck of a Tensilon tensile tester equipped with a hot air chamber, and pulled to break at a speed of 300 mm/minute in an atmosphere at 80° C. or 120° C. to measure the tensile elongation at break. Average values of the test results measured three times are shown in Table 3.

TABLE 3

| | | | | Scratch resistance test | | | |
|---|---|---|---|---|---|---|---|
| | | Weather resistance test | | 60° Gloss | 30° Gloss | | |
| | Surface | 60° Gloss | 20° Gloss | retention | retention | Tensile elongation at break test | |
| | protective | retention | retention | rate (%) | rate (%) | 80° C. | 120° C. |
| | coating | rate | rate | after scratch | immediately | Atmosphere | Atmosphere |
| | composition | (%) | (%) | recovery test | after test | (%) | (%) |
| EXAMPLE 1 | 1 | 90.9 | 86.4 | 100 | 96.2 | 161 | 57 |
| COMPARATIVE | 2 | 74.6 | 55.3 | 96.0 | 78.8 | 138 | 134 |
| EXAMPLE 1 | | | | | | | |
| COMPARATIVE | 3 | 79.5 | 60.9 | 94.2 | 90.0 | 6 | 86 |
| EXAMPLE 2 | | | | | | | |
| COMPARATIVE | 4 | 77.3 | 54.8 | 96.9 | 88.1 | 39 | 149 |
| EXAMPLE 3 | | | | | | | |
| EXAMPLE 2 | 5 | 80.4 | 64.9 | 97.1 | 83.8 | 94 | 52 |
| EXAMPLE 3 | 6 | 95.5 | 83.7 | 100 | 90.6 | 116 | 56 |
| EXAMPLE 4 | 7 | 93.9 | 70.3 | 100 | 99.5 | 50 | 31 |
| EXAMPLE 5 | 8 | 81.6 | 49.7 | 99.9 | 91.0 | 205 | 174 |
| EXAMPLE 6 | 9 | 87.6 | 70.8 | 97.9 | 79.1 | 357 | 205 |
| EXAMPLE 7 | 10 | 89.9 | 76.2 | 100 | 84.9 | 384 | 720 |
| EXAMPLE 8 | 11 | 85.1 | 82.5 | 100 | 88.2 | 269 | 108 |
| EXAMPLE 9 | 12 | 93.8 | 86.8 | 100 | 86.8 | 393 | 228 |
| EXAMPLE 10 | 13 | 87.9 | 59.8 | 99.9 | 75.8 | 800 | 400 |
| EXAMPLE 11 | 14 | 93.4 | 79.1 | 100 | 88.7 | 237 | 101 |
| COMPARATIVE | 15 | 78.4 | 30.0 | 100 | 91.6 | 345 | 132 |
| EXAMPLE 4 | | | | | | | |
| COMPARATIVE | 16 | 43.8 | 19.2 | 100 | 89.0 | 840 | 560 |
| EXAMPLE 5 | | | | | | | |
| COMPARATIVE | 17 | 92.9 | 82.3 | 100 | 95.2 | 28 | 19 |
| EXAMPLE 6 | | | | | | | |
| Reference | — | 89.8 | 68.1 | 78.0 | 78.0 | — | — |
| examples | | | | | | | |

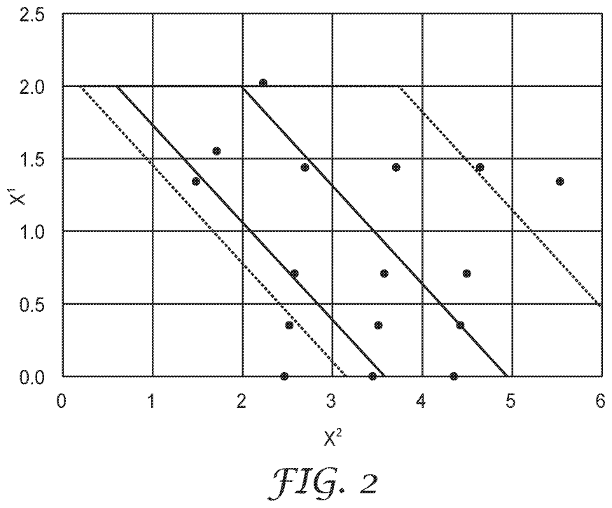

X¹ and X² in each of the surface protective coating compositions shown in Table 2 are summarized in Table 4 and the results are shown in FIG. 2. In Table 4, the polyurethane resin is designated as “PU resin”.

TABLE 4

| | | | | | | | | | | X² |
|---|---|---|---|---|---|---|---|---|---|---|
| | | | | | | | | | X¹ | Number of |
| | Surface | | IPDI | | Converted molecular weight of PU resin | | | | Number of | cyclohexane structure |
| | protective | IPDI | pre- | | | IPDI | | | branches*10³/ | portions *10³/ |
| | coating | trimer | polymer | PCDL | IPDI | pre- | | | converted molecular | converted molecular |
| | composition | (M1) | (M2) | (M3) | trimer | polymer | PCDL | Total | weight of PU resin | weight of PU resin |
| EXAMPLE 1 | 1 | 4 | 0 | 4 | 980 | 0 | 1,600 | 2,580 | 1.55 | 1.71 |
| COMPARATIVE | 2 | 4 | 0 | 4 | 980 | 0 | 1,000 | 1,980 | 2.02 | 2.23 |
| EXAMPLE 1 | | | | | | | | | | |
| COMPARATIVE | 3 | 4 | 0 | 4 | 980 | 0 | 2,000 | 2,980 | 1.34 | 5.53 |
| EXAMPLE 2 | | | | | | | | | | |
| COMPARATIVE | 4 | 4 | 0 | 4 | 980 | 0 | 1,800 | 2,780 | 1.44 | 4.64 |
| EXAMPLE 3 | | | | | | | | | | |
| EXAMPLE 2 | 5 | 4 | 0 | 4 | 980 | 0 | 1,800 | 2,780 | 1.44 | 3.71 |
| EXAMPLE 3 | 6 | 4 | 0 | 4 | 980 | 0 | 1,800 | 2,780 | 1.44 | 2.69 |
| EXAMPLE 4 | 7 | 4 | 0 | 4 | 980 | 0 | 2,000 | 2,980 | 1.34 | 1.48 |
| EXAMPLE 5 | 8 | 2 | 2 | 4 | 490 | 536 | 1,800 | 2,826 | 0.71 | 4.50 |
| EXAMPLE 6 | 9 | 1 | 3 | 4 | 245 | 803 | 1,800 | 2,848 | 0.35 | 4.42 |
| EXAMPLE 7 | 10 | 0 | 4 | 4 | 0 | 1,071 | 1,800 | 2,871 | 0 | 4.35 |
| EXAMPLE 8 | 11 | 2 | 2 | 4 | 490 | 536 | 1,800 | 2,826 | 0.71 | 3.58 |
| EXAMPLE 9 | 12 | 1 | 3 | 4 | 245 | 803 | 1,800 | 2,848 | 0.35 | 3.51 |
| EXAMPLE 10 | 13 | 0 | 4 | 4 | 0 | 1,071 | 1,800 | 2,871 | 0 | 3.45 |
| EXAMPLE 11 | 14 | 2 | 2 | 4 | 490 | 536 | 1,800 | 2,826 | 0.71 | 2.58 |
| COMPARATIVE | 15 | 1 | 3 | 4 | 245 | 803 | 1,800 | 2,848 | 0.35 | 2.52 |
| EXAMPLE 4 | | | | | | | | | | |
| COMPARATIVE | 16 | 0 | 4 | 4 | 0 | 1,071 | 1,800 | 2,871 | 0 | 2.46 |
| EXAMPLE 5 | | | | | | | | | | |

In light of the results in Table 3, from the perspective of weather resistance, scratch resistance, and elongation properties, the area defined by the dashed line in FIG. 2 shows a preferred region, and the area defined by the solid line shows a more preferable region.

It will be apparent to those skilled in the art that various modifications can be made to the embodiments and the examples described above without departing from the basic principles of the present invention. In addition, it will be apparent to those skilled in the art that various improvements and modifications of the present invention can be carried out without departing from the spirit and the scope of the present invention.

1. A decorative film comprising a surface protective layer, wherein
the surface protective layer contains a polyurethane resin obtained by reacting a composition containing a polycarbonate diol, and a trimer or higher multimer of a diisocyanate including a cyclohexane structure, a diisocyanate including a cyclohexane structure or a prepolymer thereof, or a mixture thereof; and
the decorative film satisfies Formulas 1 to 3:
0≤X¹≤2.00 Formula 1
X¹≤−0.7×X²+4.67 Formula 2
X¹≥−0.7×X²+2.14 Formula 3
where X¹ is a numerical value obtained by multiplying the number of branches from a branch point relative to a converted molecular weight of the polyurethane resin by 1000, and X² is a numerical value obtained by multiplying the number of cyclohexane structure portions included in the polyurethane resin relative to the converted molecular weight of the polyurethane resin by 1000.

2. The decorative film according to claim 1, which satisfies Formulas 2A and 3A below:
X¹≤−0.7×X²+3.43 Formula 2A
X¹≥—0.7×X²+2.43 Formula 3A.

3. The decorative film according to claim 2, which satisfies one or more of the following properties 1) to 3):
1) a 20° gloss retention rate after a weather resistance test is 75% or greater;
2) a 60° gloss retention rate immediately after a scratch resistance test is 80% or greater; and
3) a tensile elongation at break in a 120° C. atmosphere is 100% or greater.

4. The decorative film according to claim 1, wherein a proportion of a polycaprolactone diol in the composition is 10 mass % or less of the total mass of all diol components.

5. The decorative film according to claim 1, wherein the diisocyanate is isophorone diisocyanate.

6. The decorative film according to claim 1, which is used for an exterior of a vehicle.

7. A decorative article formed by covering and integrating a support member with the decorative film described in claim 1.

8. A surface protective composition comprising: a polycarbonate diol, and a trimer or higher multimer of a diisocyanate including a cyclohexane structure, a diisocyanate including a cyclohexane structure or a prepolymer thereof, or a mixture thereof, wherein the surface protective composition satisfies Formulas 1 to 3:
0≤X¹≤2.00 Formula 1
X¹≤−0.7×X²+4.67 Formula 2
X¹≥−0.7×X²+2.14 Formula 3
where X¹ is a numerical value obtained by multiplying the number of branches from a branch point relative to a converted molecular weight of a polyurethane resin prepared from the composition by 1000, and X² is a numerical value obtained by multiplying the number of cyclohexane structure portions included in a polyurethane resin prepared from the composition relative to the converted molecular weight of the polyurethane resin by 1000.

9. The surface protective composition according to claim 8, wherein the diisocyanate is isophorone diisocyanate.
